(19) United States
(12) Patent Application Publication
(10) Pub. No.: US 2025/0385457 A1
(43) Pub. Date: Dec. 18, 2025

(54) CONNECTOR

(71) Applicant: YOKOWO CO., LTD., Chiyoda-ku, Tokyo (JP)

(72) Inventor: Yoshio TAGAWA, Gunma (JP)

(73) Assignee: YOKOWO CO., LTD., Chiyoda-ku, Tokyo (JP)

(21) Appl. No.: 18/879,930

(22) PCT Filed: Jun. 26, 2023
(86) PCT No.: PCT/JP2023/023451

§ 371 Date: Dec. 30, 2024

(30) Foreign Application Priority Data
Jul. 1, 2022 (JP) 2022-107051

(51) Int. Cl. H01R 13/24; H01R 13/52

(52) U.S. Cl. CPC H01R 13/2421; H01R 13/2471; H01R 13/521

(57) ABSTRACT

A connector includes a bottomed cylindrical tube and a spring pin. The spring pin includes a contact point portion protruding from an opening of the tube, a contact portion abutting against an inner bottom surface of the tube, and an elastic deformation portion located between the contact point portion and the contact portion. in the spring pin, the contact point portion, the contact portion, and the elastic deformation portion are formed in one continuous member.

### TECHNICAL FIELD

The present invention relates to a connector.

### BACKGROUND ART

In a connector in the related art, in particular, in a structure called a so-called “pogo pin” in which a spring inside a tube biases a plunger that comes into contact with an object to be connected to achieve electrical conductivity, a stacking phenomenon may occur in which the plunger gets stuck inside a tube when making the connector shorter and thinner, resulting in a poor connection.

Therefore, a tubeless structure connector is used in which a thin plate is folded into a box shape, as described in Patent Literature 1 below. Although this solves the stacking phenomenon, it has disadvantages in terms of robustness and sealing performance after assembling to a mounting housing.

### CITATION LIST

### Patent Literature

Patent Literature 1: JP 6829082 B

### SUMMARY OF INVENTION

### Technical Problem

As described above, the stacking phenomenon may occur in the connector in which the plunger slides in the tube, and the tubeless structure has disadvantages in terms of robustness and sealing performance.

An object of the present invention is to provide a connector that is free from a stacking phenomenon, whose robustness and sealing performance can be ensured, and that can be made shorter and thinner. Other objects of the present invention will become apparent based on the present description.

### Solution to Problem

An aspect of the present invention provides a connector including:
a bottomed cylindrical tube; and
a spring pin that includes a contact point portion protruding from an opening of the tube, a contact portion abutting against an inner bottom surface of the tube, and an elastic deformation portion located between the contact point portion and the contact portion, in which the contact point portion, the contact portion, and the elastic deformation portion are formed in one continuous member.

According to the above aspect of the present invention, it is possible to provide a connector that is free from a stacking phenomenon and whose robustness and sealing performance can be ensured.

### BRIEF DESCRIPTION OF DRAWINGS

FIG. 1 is a front view of a connector according to an embodiment of the present invention, with a tube 10 in cross section.

FIG. 2 is a front view of the connector according to the embodiment of the present invention, with the tube 10 in cross section, in a state in which a spring pin 20 is pushed in.

FIG. 3 is a front view of the embodiment.

FIG. 4 is a perspective view of the embodiment.

FIG. 5 is a front view of the spring pin 20 used in the embodiment.

FIG. 6 is a front cross-sectional view of the spring pin 20.

FIG. 7 is a plan view of the spring pin 20.

FIG. 8 is a right side view of the spring pin 20.

FIG. 9 is a bottom view of the spring pin 20.

FIG. 10 is a perspective view of the spring pin 20 as viewed from substantially the upper left.

FIG. 11 is a perspective view of the spring pin 20 as viewed from substantially the upper right.

FIG. 12 is a perspective view of the spring pin 20 as viewed from substantially the lower left.

FIG. 13 is a perspective view of the spring pin 20 as viewed from substantially the lower right.

### DESCRIPTION OF EMBODIMENTS

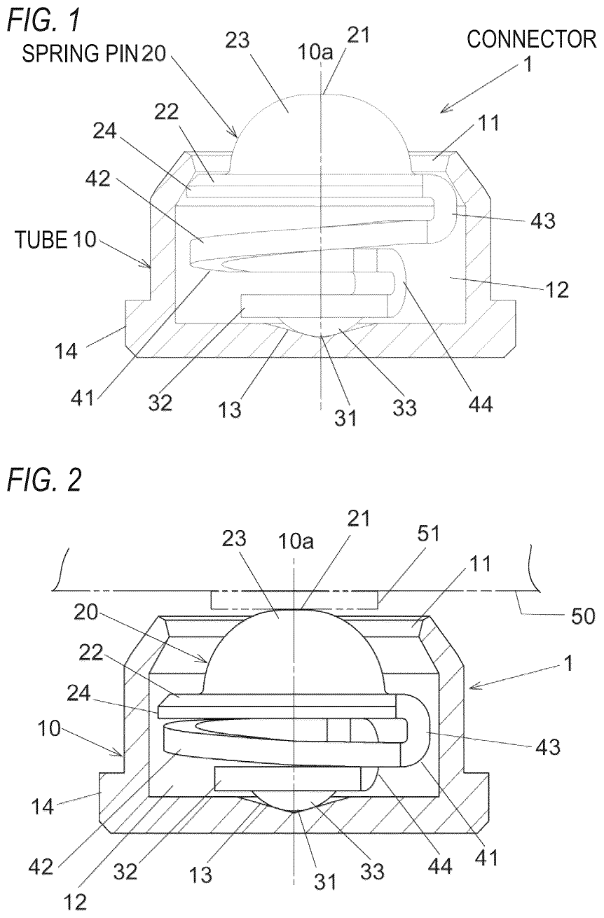

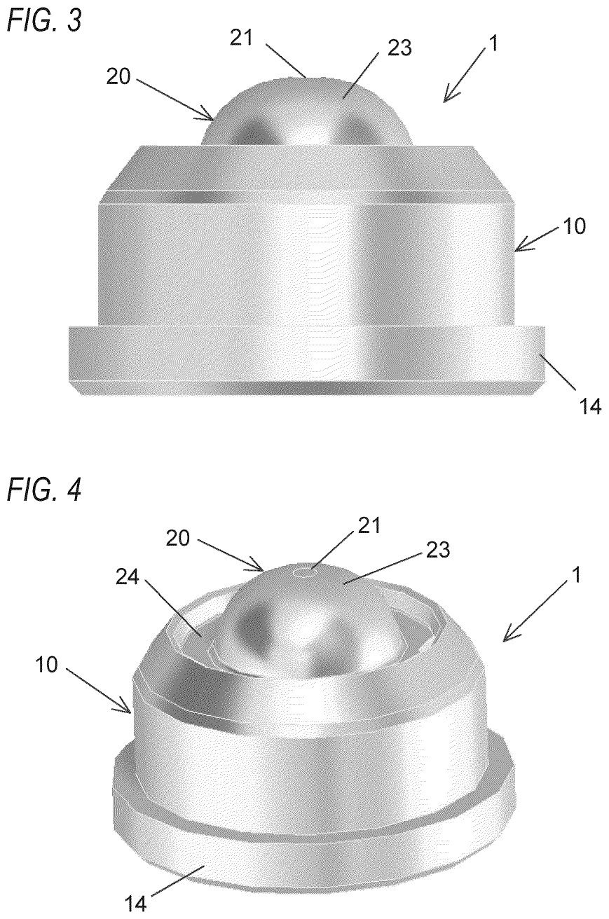

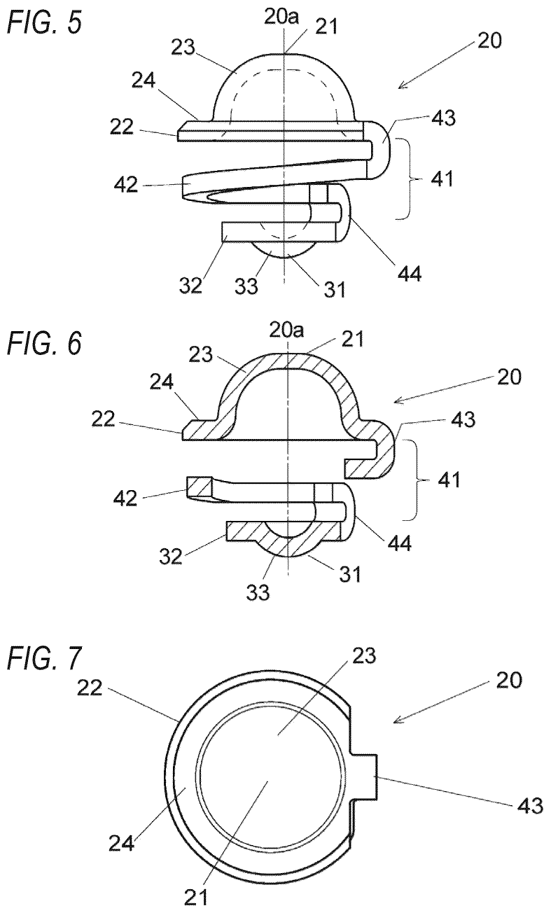

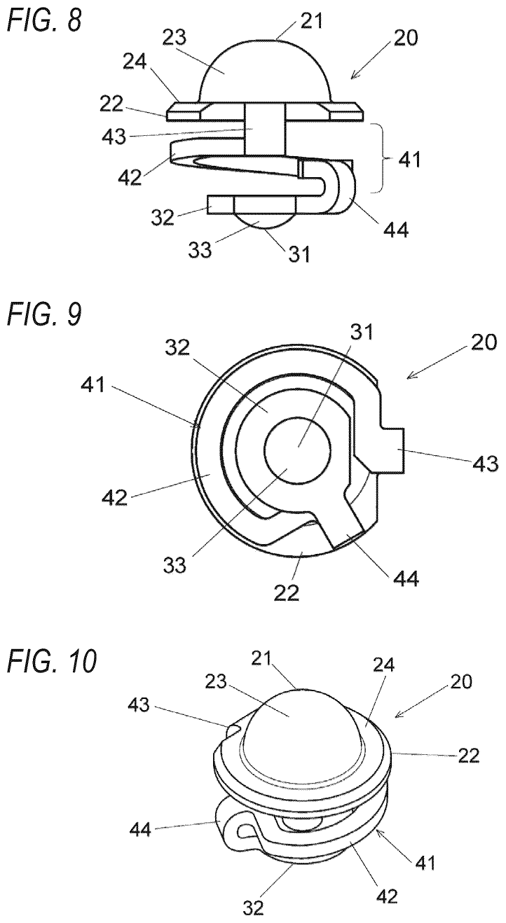

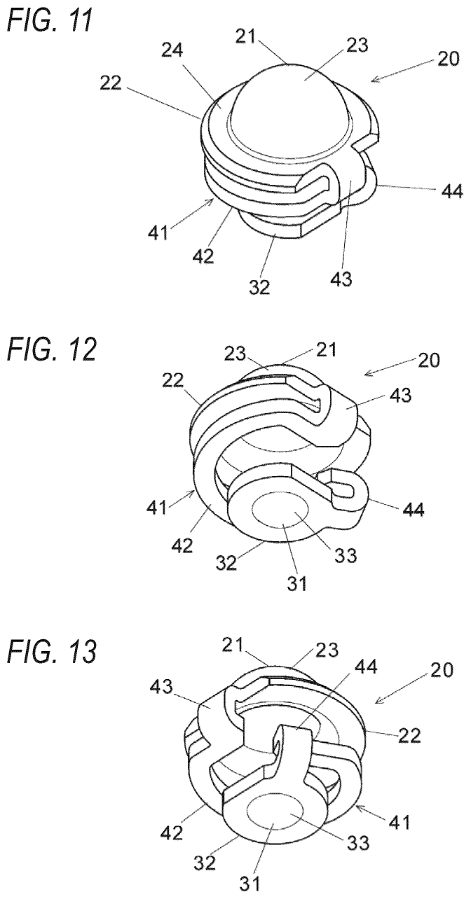

FIGS. 1 to 4 show a connector according to an embodiment of the present invention, and FIGS. 5 to 13 show a spring pin used in the embodiment. In the drawings, a connector 1 includes a conductive bottomed cylindrical tube 10, and a conductive spring pin 20 that is provided inside the tube 10 and that serves as a contact point portion 21 with one end portion protruding from an opening 11 of the tube 10 as a pressure contact portion. The bottom surface of the tube 10 according to the present embodiment has a circular shape. Alternatively, the bottom surface may have a polygonal shape such as a square or a hexagon. When the bottom surface has a polygonal shape, the tube may have a polygonal cylindrical shape that matches the bottom surface.

As shown in FIGS. 1 to 4, the tube 10 has a substantially conical recess 13 on the inner bottom surface of an inner space 12 having the opening 11. The recess 13 may be formed using a depression formed when the inner space 12 is formed by drilling. A flange portion 14 is formed on the outer periphery of the base portion of the tube 10, and the outer bottom surface of the base portion is flat such that the outer bottom surface can be used for coming into contact with the contact pad of a device in which the connector 1 is to be provided, or for soldering mounting to the device. A structure may be used in which no flange portion is provided on the outer periphery of the tube 10.

As shown in FIGS. 5 to 13, the spring pin 20 is, for example, a so-called sheet metal product that is formed by punching and bending one conductive plate material (a metal plate). Examples of the conductive material include, but are not limited to, a copper alloy such as beryllium copper, titanium copper, and phosphor bronze. The spring pin 20 includes one end portion (hereinafter referred to as a distal end portion) as the contact point portion 21, the other end portion (hereinafter referred to as a base end portion) as a contact portion 31 that abuts against the inner bottom surface of the tube 10, and an elastic deformation portion 41 serving as a spring function portion that expands and contracts between the contact point portion 21 and the contact portion 31. The spring pin 20 is provided in the inner space 12 of the tube 10, and the opening 11 of the tube 10 is crimped, so that the spring pin 20 is held inside the tube 10. The contact portion 31 and the elastic deformation portion 41 are located inside the tube 10, and the contact point portion 21 protrudes from the opening 11.

The contact point portion 21 on the distal end side is formed on a distal end side plate portion 22 as a distal end side convex portion 23 in a substantially hemispherical shape by, for example, drawing, and is a convex surface in a direction that protrudes from the tube 10. The distal end side plate portion 22 has a diameter larger than the inner diameter of the opening 11 after processing such as crimping in order to prevent detachment. Accordingly, the outer diameter of a flange-shaped portion 24 that remains around the distal end side convex portion 23 is larger than the inner diameter of the opening 11, and has a function of preventing detachment and a function of stabilizing the protruding posture of the distal end side convex portion 23.

The base end side contact portion 31 is formed on a base end side plate portion 32 as a base end side convex portion 33 in a substantially hemispherical shape by, for example, drawing, and is a convex surface that protrudes toward the inner bottom surface of the tube 10. The base end side convex portion 33 abuts against and comes into electrical contact with the substantially conical recess 13 on the tube side. In order to reduce the height dimension of the tube 10, the base end side convex portion 33 has a smaller diameter and a smaller height than the distal end side convex portion 23.

The elastic deformation portion 41 connects the distal end side plate portion 22 on the contact point portion 21 side and the base end side plate portion 32 on the contact portion 31 side, and includes an arc-shaped circumferential portion 42 that rotates approximately one full revolution, a first connecting portion 43 that connects one end of the circumferential portion 42 to the distal end side plate portion 22, and a second connecting portion 44 that connects the other end of the circumferential portion 42 to the base end side plate portion 32. In the present embodiment, since the spring pin 20 is a sheet metal product, the elastic deformation portion 41 has a width of the circumferential portion 42 in the direction perpendicular to a central axis 20a that is larger than the thickness of the circumferential portion 42 in the direction of the central axis 20a of the spring pin 20 connecting the center of the contact point portion 21 and the center of the contact portion 31 as shown in FIGS. 5 and 6. Alternatively, the thickness and width of the circumferential portion 42 may be substantially the same. The first connecting portion 43 has a length along the central axis 20a in order to ensure a predetermined gap between the distal end side plate portion 22 and the circumferential portion 42. Similarly, the second connecting portion 44 has a length along the central axis 20a in order to ensure a predetermined gap between the base end side plate portion 32 and the circumferential portion 42.

The outer circumferential diameter of the base end side plate portion 32 is set smaller than the inner circumferential diameter of the arc-shaped circumferential portion 42. This is effective in ensuring the expansion and contraction stroke of the elastic deformation portion 41 by preventing the circumferential portion 42 from hitting the base end side plate portion 32 when the elastic deformation portion 41 is compressed. Preferably, the spring pin 20 is provided in the tube 10 such that the direction of the central axis 10a of the tube 10 shown in FIGS. 1 and 2 substantially coincides with the direction of a center line 20a of the spring pin 20.

In the configuration according to the above embodiment, as shown in FIG. 2, for example, an electrode 51 of a mating device 50 abuts against the contact point portion 21 of the spring pin 20 of the connector 1, and pushes the spring pin 20 in. As a result, the elastic deformation portion 41 of the spring pin 20 is compressed in a direction along the central axis 10a of the tube 10, and the spring function applies a predetermined contact pressure between the mating electrode 51 and the contact point portion 21, thereby ensuring electrical connection between the mating electrode 51 and the contact point portion 21. On the other hand, the contact portion 31 of the spring pin 20 also abuts against the recess 13 of the inner bottom surface of the tube 10 at a predetermined contact pressure, thereby ensuring electrical connection between the spring pin 20 and the tube 10. As a result, an electrical conduction path leading to the electrode 51 of the mating device 50, the spring pin 20, and the tube 10 is formed, and electrical connection is reliably performed between the mating device 50 and the device to which the tube 10 is attached (connected).

According to the present embodiment, the following effects can be achieved.

(1) In the connector 1, the periphery of the spring pin 20 is surrounded by the bottomed cylindrical tube 10 with the spring pin 20 provided inside, and thus the connector 1 is more robust than a tubeless structure in the related art in which a thin plate is folded back into a box shape. For example, it is possible to prevent the spring pin 20 from shifting sideways and from being excessively deformed when pressed in. Since the device can be press-fitted into the mounting housing or sealed with resin, this has an advantage of improving the sealing performance after assembling to the mounting housing.

(2) The spring pin 20 includes the elastic deformation portion 41 between the contact point portion 21 and the contact portion 31, which can be efficiently manufactured as a sheet metal product. In the spring pin 20 the contact point portion 21, the contact portion 31, and the elastic deformation portion 41 are formed in one continuous member, so that it is possible to make the spring pin 20 shorter and thinner as compared with a structure in the related art in which the plunger and the spring are separate, and it is also possible to reduce the number of components.

(3) The plunger and the spring are integrated into the spring pin 20, which has a base end side that is electrically conductive to the tube 10. This eliminates the need to tilt the spring pin 20 relative to the central axis 10a of the tube, and a stacking phenomenon is less likely to occur.

(4) Since the recess 13 is formed in the inner bottom surface of the tube 10 and the contact portion 31 of the spring pin 20 includes the base end side convex portion 33 that abuts against the recess 13, the contact region between the two is clarified, and the electrical connection is stabilized. That is, the contact pressure due to the spring function of the elastic deformation portion 41 is applied to the contact region between the recess 13 and the base end side convex portion 33, and reliable electrical connection between the tube 10 and the spring pin 20 is possible. Since the recess 13 is generated by drilling when the inner space 12 is formed, a manufacturing process for forming the recess 13 is not required, and the number of manufacturing processes does not increase.

(5) In the spring pin 20, the distal end side convex portion 23 of the contact point portion 21 and the base end side convex portion 33 of the contact portion 31 can be easily formed by pressing, and the spring pin 20 can be efficiently manufactured.

(6) The elastic deformation portion 41 includes the arc-shaped circumferential portion 42, and the outer circumferential diameter of the base end side plate portion 32 on which the base end side convex portion 33 is formed is smaller than the inner circumferential diameter of the circumferential portion 42. Therefore, it is possible to prevent the circumferential portion 42 from hitting the base end side plate portion 32 and to ensure a sufficient stroke for expansion and contraction of the elastic deformation portion 41, which leads to a reduction in the height of the spring pin.

(7) Since the flange portion 14 is formed at the base portion of the tube 10, for example, by forming a two-step hole or the like corresponding to the flange portion 14 on the mounting housing side, it is easy to mount the connector 1 to the mounting housing side.

Embodiments and modifications of the present invention have been described above with reference to the drawings, but these embodiments and modifications are examples of the present invention, and various configurations other than those described above can also be used.

In the embodiment, the recess 13 is formed in the inner bottom surface of the tube 10, and the base end side convex portion 33 is formed on the spring pin 20 side, so that contact is achieved by the recess and the convex portion. The present invention is not limited to this configuration, and the recess 13 and/or the base end side convex portion 33 may be omitted. That is, the bottom surface (the bottom surface of the base end side plate portion 32) of the base end portion of the spring pin 20 may be brought into contact with the inner bottom surface of the tube 10. Accordingly, the electrical connection between the spring pin 20 and the tube 10 is stabilized. Wobbling of the spring pin 20 can be reduced.

In the embodiment, the elastic deformation portion 41 of the spring pin 20 includes one arc-shaped circumferential portion 42. The present invention is not limited to this configuration, and a plurality of arc-shaped circumferential portions may be provided to increase the expansion and contraction stroke. In this case, the circumferential portion may have an outer circumferential diameter that decreases toward the base end portion, with the base end side circumferential portion fitting inside the distal end side circumferential portion. Accordingly, the expansion and contraction stroke and the length of the spring pin 20 can be freely set.

In the embodiment, the spring pin 20 is held inside the tube 10 by crimping the opening 11 of the tube 10. Alternatively, the spring pin 20 may be held by a separate mechanism. For example, a mechanism may be used in which, after the spring pin 20 is placed on the tube 10, a through cylindrical portion whose one end is crimped inward or whose inner peripheral surface is stepped on is press-fitted between the tube 10 and the spring pin 20 to prevent the spring pin 20 from coming off. By holding the spring pin 20 together with the tube 10 on a separate body such as the through cylindrical portion, there are no processing restrictions and manufacturing is simpler than if the spring pin 20 is crimped to the tube 10. When the length of the spring pin 20 differs, there is no need to design the tube 10 for each length, which has the advantage that the components can be standardized. In addition, since the plating type can be changed between the tube 10 and the through cylindrical portion, it is possible to improve durability, corrosion resistance, and the like, or to reduce costs by eliminating unnecessary plating.

According to the present description, a connector according to the following aspects is provided.

### (Aspect 1)

An aspect 1 of the present invention provides a connector including:
a bottomed cylindrical tube; and
a spring pin that includes a contact point portion protruding from an opening of the tube, a contact portion abutting against an inner bottom surface of the tube, and an elastic deformation portion located between the contact point portion and the contact portion, in which the contact point portion, the contact portion, and the elastic deformation portion are formed in one continuous member.

According to the aspect 1 described above, since the periphery of the spring pin is surrounded by the tube, the connector is more robust than a tubeless product in the related art in which a thin plate is folded back into a box shape. For example, it is possible to prevent the spring pin from shifting sideways and from being excessively deformed when pressed in. This has an advantage that the present invention can be applied to applications in which the device is sealed with resin after assembling to the mounting housing. The spring pin has an integral structure in which the contact point portion, the contact portion, and the elastic deformation portion are continuous, and can be made thinner and shorter as compared with a structure in the related art in which the plunger and the spring are separate. The number of components can be reduced. Further, the spring pin has a base end side that is electrically conductive to the tube. This eliminates the need to tilt the spring pin relative to the central axis of the tube, and a stacking phenomenon is less likely to occur.

### (Aspect 2)

In an aspect 2, a recess is formed in the inner bottom surface of the tube, and the contact portion includes a convex portion that abuts against the recess.

According to the aspect 2 described above, the contact region between the contact portion of the spring pin and the tube becomes clear, and the electrical connection is stabilized. That is, the contact pressure due to the spring function of the elastic deformation portion is applied to the contact region between the recess and the convex portion, and reliable electrical connection between the tube and the spring pin is possible. Since the recess is generated by drilling when the tube inner space is formed, a manufacturing process for forming the recess is not required, and the number of manufacturing processes does not increase.

### (Aspect 3)

In an aspect 3, the spring pin includes a base end side plate portion, and the convex portion of the contact portion is formed as a substantially hemispherical convex portion on the base end side plate portion.

According to the aspect 3 described above, the convex portion of the contact portion can be easily formed by pressing.

### (Aspect 4)

In an aspect 4, the contact point portion is formed as a substantially hemispherical convex portion that protrudes from the tube.

According to the aspect 4 described above, the contact point portion can be formed more easily by pressing.

### (Aspect 5)

In an aspect 5, the elastic deformation portion includes an arc-shaped circumferential portion, and an outer circumferential diameter of the base end side plate portion is smaller than an inner circumferential diameter of the circumferential portion.

According to the aspect 5 described above, the stroke for expansion and contraction of the elastic deformation portion, that is, the expansion and contraction stroke of the spring pin can be sufficiently ensured.

### (Aspect 6)

In an aspect 6, the elastic deformation portion includes an arc-shaped circumferential portion, and an outer circumferential diameter of the circumferential portion decreases from the contact point portion toward the contact portion.

According to the sixth aspect described above, since the outer diameter of the circumferential portion decreases from the contact point portion toward the contact portion. Accordingly, when a plurality of the circumferential portions are provided, the circumferential portion on the base end portion side is fitted to the inner side of the circumferential portion on the distal end portion side, which is effective in increasing the stroke of the elastic deformation portion.

### REFERENCE SIGNS LIST

1: connector
10: tube
11: opening
12: inner space
13: recess
14: flange portion
20: spring pin
21: contact point portion
22: distal end side plate portion
23: distal end side convex portion
24: flange-shaped portion
31: contact portion
32: base end side plate portion
33: base end side convex portion
41: elastic deformation portion
42: circumferential portion
43, 44: connecting portion

1. A connector comprising:
a bottomed cylindrical tube; and
a spring pin that includes a contact point portion protruding from an opening of the tube, a contact portion abutting against an inner bottom surface of the tube, and an elastic deformation portion located between the contact point portion and the contact portion, in which the contact point portion, the contact portion, and the elastic deformation portion are formed in one continuous member.

2. The connector according to claim 1,
wherein a recess is formed in the inner bottom surface of the tube, and the contact portion includes a convex portion that abuts against the recess.

3. The connector according to claim 2,
wherein the spring pin includes a base end side plate portion, and the convex portion of the contact portion is formed as a substantially hemispherical convex portion on the base end side plate portion.

4. The connector according to claim 1,
wherein the contact point portion is formed as a substantially hemispherical convex portion that protrudes from the tube.

5. The connector according to claim 3,
wherein the elastic deformation portion includes an arc-shaped circumferential portion, and an outer circumferential diameter of the base end side plate portion is smaller than an inner circumferential diameter of the circumferential portion.

6. The connector according to claim 1,
wherein the elastic deformation portion includes an arc-shaped circumferential portion, and an outer circumferential diameter of the circumferential portion decreases from the contact point portion toward the contact portion.
